(19) United States
(12) Patent Application Publication
(10) Pub. No.: US 2009/0125381 A1
(43) Pub. Date: May 14, 2009

(54) METHODS FOR IDENTIFYING DOCUMENTS RELATING TO A MARKET

(75) Inventor: Rajiv Delepet, Santa Monica, CA (US)

Correspondence Address: FISH & ASSOCIATES, PC;ROBERT D. FISH, 2603 Main Street, Suite 1000, Irvine, CA, 92614-6232, US

(73) Assignee: WISE WINDOW INC., Santa Monica, CA (US)

(21) Appl. No.: 12/265,107

(22) Filed: Nov. 5, 2008

Related U.S. Application Data
(60) Provisional application No. 60/986,121, filed on Nov. 7, 2007.

(51) Int. Cl. G06Q 30/00; G06F 7/06; G06F 17/30

(52) U.S. Cl. 705/10; 707/5; 707/E17.108

(57) ABSTRACT

Methods of identifying web documents as relating to a market domain that would ordinarily be considered unrelated are presented. Market domain criteria can be defined that provide for classifying web documents as being related to the domain. The documents classified as related to the market domain form a training sample of documents used to establish correlations among brand term combinations found within the documents. If correlations are established among the terms in a combination, the term combinations can be assigned a similarity score indicating how similar the terms are considered to be. The term combinations can be used to search for additional web documents that could pertain to the market domain but would otherwise fail to satisfy the market domain criteria. The search results can be presented via a computer interface according to similarity scores.

This application the benefit of priority to U.S. Provisional Application 60/986,121 filed Nov. 7, 2007. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is marketing technologies.

### BACKGROUND

Marketing analytic technologies often generate poor results due to researches unknowingly introducing bias while conducting an analysis. Such issues are especially problematic when attempting to use Internet accessible web documents to establish various interesting market-related relationships including brand recognition, buzz, sentiment, customer loyalty, or other relationships. For example, a researcher can accidentally bias results by merely typing a search term in a search engine where the term is overly restrictive, which returns results having documents matching the search term (e.g., product literature, advertisements, etc. . . . ) as opposed to other additional documents lacking the term that might also be pertinent (e.g., articles, blogs, news stories, etc. . . . ).

Ideally a researcher should be able to collect brand data by crawling the web with little or no bias. Unfortunately, crawling the web for web documents having data pertinent to a market domain can be quite difficult due to the shear volume of documents available and the varied ways brand data could be represented. Some web documents are clearly related to a market domain, possibly actually having a proper name or logo, while other pertinent documents appear to be completely unrelated to the marketing domain. Still, the unrelated documents might be pertinent to a marketing analysis project. For example, a researcher might wish to analyze the brand SONY™ and enter “Sony” as a search terms to find market related documents. However, the researcher would miss documents where “Sony” is misspelled, or miss documents lacking the word “Sony” where other terms could pertain to Sony, “PlayStation” for example. To overcome the difficulties, the researcher is forced back to properly defining search terms which again can introduce bias. To address these issues, researchers require some means for identifying web documents that could be pertinent to a marketing domain while reducing the risk of introducing or being exposed to bias.

What has yet to be appreciated is that valuable marketing domain information can be garnered from web documents that appear to be unrelated to a market domain of interest. The unrelated documents can be identified by first analyzing web documents that are known to be related to the domain. The analysis can automatically determine if there are unbiased correlations between various combinations of terms used within the documents. For example, “Sony” could be correlated with “Sny” or even a type of product such as “TV”. The correlations can then be used to determine if various terms are sufficiently similar to each other. The terms, or combinations of terms, can then be used to search for unrelated web documents having correlated terms. The researcher can then extract desirable data from the returned unrelated documents including buzz, trends, loyalty, or other interesting marketing information.

Others has put forth effort to address some of the issues associated with market analytics. For example, U.S. Patent Application Publication 2005/0131935 to O'Leary et al. describes a content mining system that uses a combination of term recognition and rules-based classifications to identify sector or vertical market significant information. Another example includes U.S. Patent Application Publication 2006/0069580 to Nigam et al., which describes methods of performing topical sentiment analysis on stored communications. However, both of these references, as well as other know art, fail to provide for finding web documents that could pertain to a market domain while appearing unrelated to the domain.

The disclosed techniques can be used within marketing analytic applications as described in co-owned U.S. patent application Ser. No. 12/253,541 titled “Systems And Methods Of Providing Market Analytics For A Brand” filed on Oct. 17, 2008; and co-owned U.S. patent application Ser. No. 12/253,567 titled “Systems And Method Of Deriving A Sentiment Relating To A Brand” also filed Oct. 17, 2008. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for methods of identifying marketing documents pertinent to a marketing domain.

### SUMMARY OF THE INVENTION

The inventive subject matter provides apparatus, systems and methods in which web documents pertinent to a marketing domain can be identified by establishing correlations among various brand oriented terms. In one aspect of the inventive subject matter, web documents can be classified as being related to a specific market domain, preferably according to domain criteria having one or more rules. Web documents that satisfy the criteria can be considered to be related to the domain. The resulting group of documents can be analyzed with respect to combinations of brand terms where each combination has at least two terms. Correlations can be established for the various combinations of terms based on the usage of the terms within the web documents. The correlations can be used to indicate how similar the terms are within each combination and can be used to assign similarity scores to the combinations. Additional web documents unrelated to the market domain (e.g., web documents that do not satisfy the rules of the domain criteria) can be searched and analyzed using various aspects of the term combinations. In a preferred embodiment, the unrelated web documents can be presented to via a computer interface according to the similarity scores.

In some embodiments the system can run automatically, possibly continuously, where web documents can be classified automatically based on search terms. An initial group of web documents classified as relating to a market domain can also be updated automatically as changes in the web documents are detected or other related web documents are uncovered. Preferred web documents include documents from e-commerce sites, reviews, articles, or other network accessible documents.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic overview of a system where web documents are classified as being related to a market domain.

FIG. 2 is a schematic of identifying term combinations of terms occurring in web documents related to a market domain.

FIG. 3A is a schematic of establishing correlations between terms in term combinations based on how the terms are used.

FIG. 3B is a schematic of assigning similarity scores to term combinations.

FIG. 4 is a schematic of presenting web documents according to similarity scores.

### DETAILED DESCRIPTION

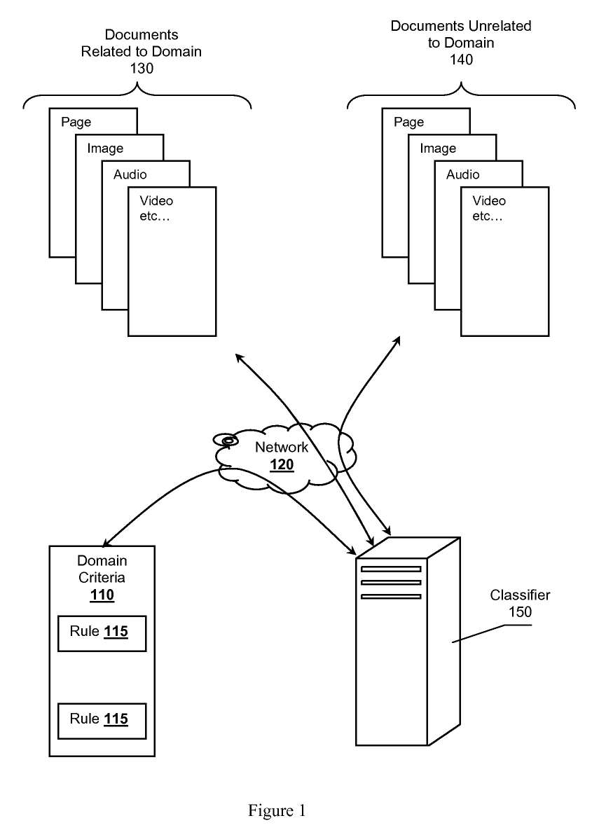

In FIG. 1, web documents are classified as being related to a specified market domain based on domain criteria 110. Domain criteria 110 can comprises one or more rules 115 to facilitate classification of various web documents as being documents 130 related to the domain or as being documents 140 that are unrelated to the domain. In a preferred embodiment, domain criteria 110 are submitted to a computer system operating as classifier 150. Classifier 150 uses rules 115 to search for web documents that match criteria 110.

The web documents classified by classifier 150 preferably include Internet accessible documents that can be obtained publicly via the World Wide Web. In a preferred embodiment, the documents comprise digital data representing various web pages, data files, images, audio files, video, or other digital documents that can be accessed by a computer system. Especially preferred web document include those web documents that include digital data representing text (e.g., ASCII, UNICODE, etc. . . . ) that can be searched by direct comparison to a search string. Other documents include those having image data, video data, audio data, or other forms of digital data can also be searched electronically to find document content that matches criteria 110.

Web documents can include content data or metadata. Content data represents the data actually contained within the document, which includes any text, image data, audio data, or other forms of content data. Metadata represents data associated with the document that describes the document itself. Examples of metadata include timestamps, creator information, source information, ratings, attributes, tags, file name, file extension, owner, or other information describing the document itself as opposed to the content. In some embodiments, metadata can be represented digitally through the use of a markup language, possibly based on XML. Metadata allows classifier 150, at some level, to classify a document based on a semantic meaning of the documents according to domain criteria 110.

In a preferred embodiment, domain criteria 110 provides classifier 150 with one or more rules 115 defining how to classify web documents that are considered to be related to a specific market domain. Rules 115 preferably can be programmed into a computer system operating as classifier 150. For example, rules 115 can include simple search string queries; image recognition algorithms to identify faces, products, trademarks, logo, etc. . . . ; audio recognition algorithms to identify sound bites, names, slogans, etc. . . . ; or other programmatic functions.

Consider, for example, a researcher that wishes to research how Sony is branded. A researcher could define criteria 110 to have a rule that requires a web document to include a text string that matches the string “Sony”. Additionally, a rule could be defined that requires a web document to have a sound bite that has audio data matching the pronunciation of “Sony”, or to have a Sony logo. Rules could also be based on business codes (e.g., NAICS, SIC, etc. . . . ) or even on export codes (e.g., ECCN, etc. . . . ). The rules can be arbitrarily complex beyond the simply examples previously provided.

In some embodiments, web documents are automatically identified as a function of a search term that represents the market domain where the search term is encoded in a rule 115. A term can include key words, image data, audio data, or other forms of digital data. Web documents can be identified based on direct matches to the search terms or based on indirect matches. A direct match could be a literal data match where an indirect match could be based on correlation of terms as described below or through matches obtained once data formats within the web documents are rectified. Indirect matches preferably include a confidence level to allow a researcher to improved relevance of web documents relating to the market domain by removing documents that fall outside the envelop of desirable confidence levels.

Preferred criteria 110 are considered dynamic objects that can vary with time. As time passes, web documents can change or new web documents can become available. Consequently, criteria 110 used to classify web documents as relating to a specified market domain can also change to reflect the current state of a market. In response, criteria 110 can be updated automatically by adding, deleting, or modifying rules 115 to properly reflect market state. In some embodiments, a human being initially classifies web documents as documents 130 relating to a domain to prime an analysis engine. As the system conducts term combination analysis, described below, the resulting correlations can be fed back into criteria 110 automatically without requiring further human interaction where the feedback can be used to alter criteria 110. Such an approach provides for adaptively following trends, buzz, or sentiment while reducing the risk of a researcher introducing bias into an analysis.

Bias could be accidentally introduced depending on how a researcher or other entity defines criteria 110. However, given that a preferred criteria 110 is dynamic, criteria 110 or rules 115 can be updated automatically to reduce, or eliminate the risk of bias. As discussed above, criteria 110 can be updated automatically based on observed trends or relationships. In some embodiments, a criteria interface is offered to a researcher to allow the researcher to maintain the health of criteria 110 or to observe its growth. A preferred criteria interface allows a researcher to add, delete, update, activate, deactivate, or modify rules 115 as desires or necessary to prevent the system from running in an unbounded fashion. For example, a researcher could use the interface to deactivate rules 115 after allowing the system to form a group of documents 130 for one day or other reasonable amount of time.

Classifier 150 preferably classifies web documents according criteria 110 as being in a group of document 130 relating to a specified market domain or as being in a group of documents 140 unrelated to the market domain. As used herein, the term “related” or “relating” to a market domain should be considered to mean that a document satisfies criteria 110. Conversely, “unrelated” to a market domain is considered to mean that a document does not satisfy criteria 110.

Documents 130 that are considered to be related to a specified market domain can be considered a training sample of documents to provide a foundation for identifying other web documents that are pertinent to a researcher's quest but would otherwise be unrelated to the market domain. A marketing analysis engine operating according to the disclosed techniques can also automatically update documents 130. As content on the web changes, it is contemplated that the engine can continually crawl the web for additional documents 130 that satisfy criteria 110.

Preferred documents 130 relating to a specified market domain include documents having a more formal presentation offering a more structured use of language, images, or audio. Example preferred web documents 130 include product reviews, documents sourced from e-commerce sites, or other documents that are more formal in nature. Especially preferred documents include documents that have a quantified rating for a marketing related entity (e.g., product, company, service, movie, etc. . . . ). Such rating documents provide for generating term combinations that can be quantified. For example, if a review states that a game is great and has a rating of 8.5, then the term “great” could be correlated to “8.5”.

The preferred more formal documents 130 ensure the system can establish strong correlations among terms. Once correlations among term combinations are established as discussed below, unrelated web documents 140 can be identified as pertaining to the market domain. Preferred web documents 140 are more informal and can include articles authored by individuals other than those related to a company, brand, or product of interest. Preferred articles include blogs, forum posts, or news stories. Such articles provide support for establishing marketing trends, buzz, or sentiment among the general unbiased consumer base as opposed to trends, buzz, or sentiment engineered by a biased company or advertising firm.

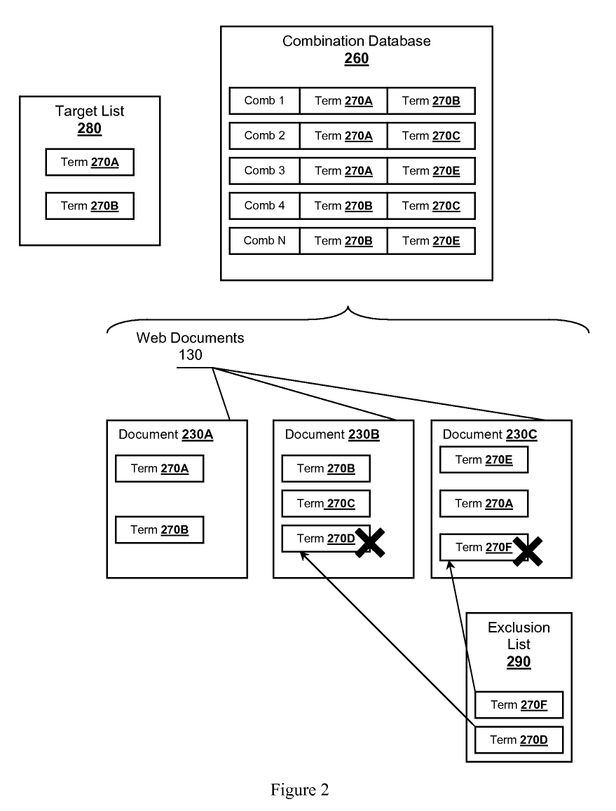

In FIG. 2, documents 130 are preferably analyzed to identify a set of brand term combination where each combination includes at least two different terms occurring within documents 130. Documents 130, for example, can include one or more of documents 230A, 230B, or 230C.

In a preferred embodiment, a computer system storing software instructions on a computer media executes the instructions to identify various combinations of two or more of terms 270A through 270N, collectively referred to as terms 270. The computer system can store the term combinations in a memory to create combination database 260. Database 260 can be stored in any suitable memory including a volatile memory or non-volatile memory, possibly on disk drives.

Terms 270A through 270E are preferably digital data representing content within documents 230A through 230C. It is also contemplated that terms 270 could include digital data used to represent metadata of documents 130. In a preferred embodiment, terms 270 correspond to brand terms relating to a market domain can include data representing companies, businesses, organizations, products, services, technologies, standards, product classes, or other types of marketing oriented data. Preferred terms include names relating to marketing entities. Terms 270 are preferably represented digitally by a text string, a portion of an image, or a sound bite of audio data. It is also contemplated that a term could include compound terms where several words, sound bites, or images could form a single token. For example, “Sony Television” could be a token that is considered a single term. Furthermore, it should be note that the disclosed techniques are language agnostic became terms 270A through 270E are represented as digital data. The techniques can be equally applied to English, Japanese, Chinese, or any other language.

Term combinations can be identified by searching each of documents 230A through 230C individually or collectively. For example, the computer system conducting the identification process could be programmed to identify only combinations that appear in individual documents as represented by document 230A where term combination 1 includes term 270A and term 270B. Additionally, the system can be programmed to bridge documents as represented by documents 230B and 230C where combinations 2 through N are found spread across one than one document. Term combinations can also be identified even if one of the terms originates from a different language that another term in the combination. This can be achieved because each term is represented as digital data forming a language agnostic token.

It should be noted that the number of term combinations identified can be quite extensive depending on the nature or number of documents 130. The number of term combinations can be quenched or bounded through numerous possible means. In a preferred embodiment, only those term combinations having terms within target list 290. For example, target list 290 could include terms 270A and 270B. In which case, only terms combinations having these terms are included in database 260. Furthermore, the system can include exclusion list 290 which includes one or more terms, terms 270D or 270F for example, which are ignored while identifying sets of term combinations.

Target list 280 provides for developing refined correlations among brand terms. For example, a researcher could require that all term combinations including some form of “Sony” (e.g., literal text, image, logo, sound, etc. . . . ). Exclusion list 290 can be used to reduce the shear number of possible combinations that could result from automatically identifying combinations having common terms, for example combinations having the words “the”, “and”, “of”, or other words that would ordinarily lack relevance.

One should note that target list 280 or exclusion list 290 can comprise more than a mere listing of terms. Contemplated lists can also incorporate on or more rules comprising various algorithms to help further define acceptable terms. The rules can be applied to content data or even metadata. For example, a simple rule could require acceptable combinations to have terms that are within certain proximity of each other.

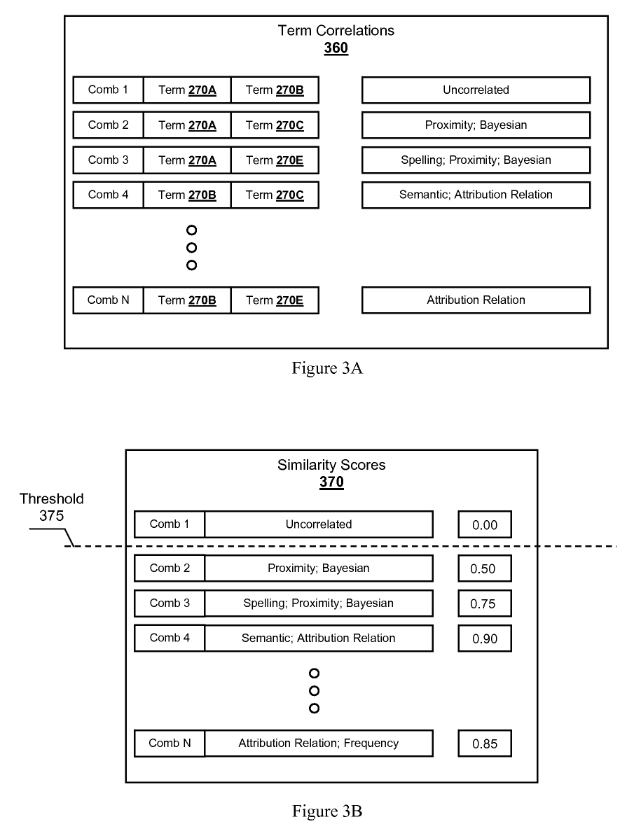

In FIG. 3A, term correlations 360 are established among terms 270 in each of the combinations based usage of each term. One or more algorithms are applied to the web documents to determine if the terms are indeed correlated based on their usage. As used herein, “usage” should be interpreted to mean how a term is placed within a document in relation to other data as determined algorithmically. For example, a plurality of algorithms can be applied to web documents to establish if terms 270A and 270B are correlated. If the algorithms return a NULL result, or if a result falls below a usage threshold, the term combination is considered to be uncorrelated as illustrated in combination 1 where term 270A and 270B are found to uncorrelated. However, if the correlation algorithms return an acceptable result, the terms within the combination are considered to be correlated as shown in combinations 2 through N.

Many suitable algorithms can be used to establish term correlations among terms in a term combinations. Preferred algorithms include those based on Bayesian statistics, proximity of terms in relation to each other or across documents, spelling, differences between the digital data used to represent the brand terms, latent semantic analysis, frequency of occurrences of terms, or relationships of attributes associated with the terms.

Bayesian based algorithms uses the initial training sample web documents to determine if terms within a term combination are related in a similar fashion as used for SPAM filtering. The results can then be applied to unrelated documents to determine if they are pertinent to the domain based on a similarity score.

Proximity based algorithms operate by analyzing the neighbor hood around the various terms within the web documents to find similar data structures. For example, the word “Sony” could be a first brand term within a first web document and could be located within ten words of “television”. Another word, “PlayStation”, could be a second term and also be within ten word of “television” within a second web document. The two terms, “Sony” and “PlayStation” could then be correlated based on inferred proximity searching. Proximity based algorithms can also be based on other types of proximity other than mere distance with respect to words. Other types of proximity can include proximity based on time (e.g., a timestamp when a terms is referenced in video data, audio data, or a timestamp of a document update or creation), pixel or vector distances of objects within images, or qualitative nearness of web documents within a market domain where a number of domain criteria links that relate two documents can be used as a measure of “nearness” within a domain.

Spelling-based algorithms operate by looking for the actual representation of text used within a document. Words are often misspelled, especially in more informal web documents including blogs, forums, or comment fields of web pages. The spelling algorithms determine if two terms are likely correlated by how similar they are represented in digital data. Common spell-checkers represent suitable candidates for adaptation as a spelling-based term correlation algorithm

Similar to spelling, terms can be analyzed with respect to the data used to represent the terms. In some embodiments where the web documents include images, audio, video, or even text, the terms are converted from a data format used to encode the term (e.g., MPEG, JPG, PNG, BMP, MP3, ASCII, UNICODE, etc. . . . ) to a normalized format so that the terms can be analyzed properly. A term correlation algorithm can then determine the usage of the terms based on differences between the digital data represent the terms.

Term correlations can also be established based on the frequency of occurrence of the terms within the web documents. For example, marketing literature (e.g., a company's web site, data sheets, white papers, etc. . . . ) could be analyzed to determine if the terms within a term combination have similar frequency of occurrences on within the same document. If they do have the same frequency within some threshold, they could be flagged as correlated. Frequency of occurrence can be applied to each term individually, to at least two of the terms observed on the same document, or even to the entire combination.

In some embodiments, term correlations are established based on the relationships of attributes assigned to the terms. Although terms 270 are presented as being a single value, in some embodiments terms could comprise one or more attributes as assigned by a user or as derived by the computer system. The attributes of the terms can be compared with each other within the context of their web documents to establish relationships. For example, the term “Sony” could be tagged with attributes similar to the set (“company”, “electronics”, “games”), and a second term “PlayStation” could be tagged with attributes similar to the set (“games”, “electronics”, “console”). Given the match between attributes, the terms “Sony” and “PlayStation” could be correlated. One should appreciate that this example is simplistic and that attribute relationship algorithms can be much more complex.

Although various examples of term correlation algorithms have been presented to determine correlations based on term usage, many other suitable algorithms are also contemplated including adapting known methods of latent semantic analysis. All correlation algorithms are contemplated and can be applied to the inventive subject matter.

In FIG. 3B, the term combinations 1 through N are preferably assigned similarity scores 370 as a function of the term correlations. Similarity scores 370 can be single-valued numbers as illustrated, possibly directly resulting from the various algorithms. In some embodiments, scores 370 are normalized to represent a probability that the terms of the combinations are indeed correlated. It is also specifically contemplated that scores 370 could be multi-valued where each value represents a possible different aspect of a correlation. For example, each value could be a probability value returned from each algorithm, or multiple values returned from a single algorithm.

In a preferred embodiment, some of combinations 1 through N are eliminated from consideration when the combinations have scores that are outside the scope of a threshold constraint. For example as illustrated in FIG. 3B, combination 1 could be eliminated because its score of 0.00 falls below threshold 375. Just as a similarity score can comprise multiple values, a threshold constraint can be multi-valued, possibly including programmatic logic to define an envelope of desirable combinations.

Preferred similarity scores 370 can change with time. As content on the web comes, goes, or is altered, the marketing information for a domain can also change. It is contemplated that a marketing analysis engine utilizing the disclosed technique can run analyses as a background service for a researcher and present updated similarity scores, possibly updating the scores periodically (e.g., every minute, hour, day, week, month, etc. . . . ). In a preferred embodiment an analysis engine provides access to a history of the set of combinations or their similarity scores. Such an approach can be used to determine market trends as a function of time, geography, or other parameter.

A researcher armed with term combinations and possibly with similarity scores can identify additional web documents of interest that were originally considered unrelated to the market domain (e.g., documents that fell outside the scope of a specified domain criteria).

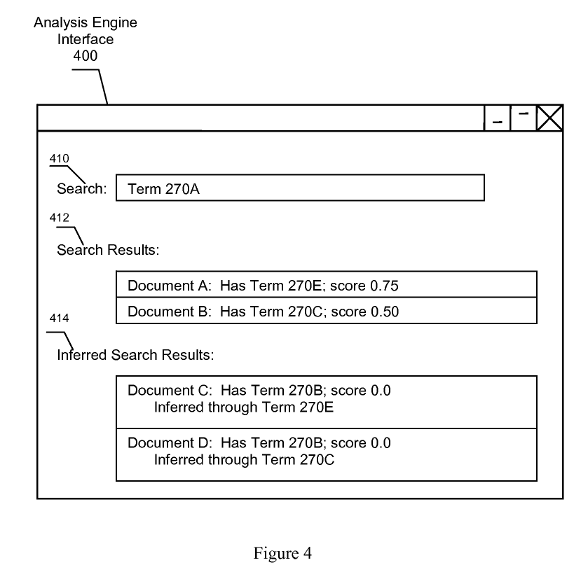

FIG. 4 presents an exemplary embodiment where a researcher can identify unrelated web documents as pertaining to a market domain using analysis engine interface 400. In a preferred embodiment, interface 400 is part of a marketing analysis platform capable of providing analytics. An example of a suitable marketing analysis platform includes those provided by Wise Windows, Inc. of Santa Monica, Calif. (http://www.wisewindows.com). The disclosed techniques can be used to as a foundational element for identifying marketing buzz, trends, sentiment, or other marketing analytics as discussed in co-owned U.S. patent application having Ser. No. 12/253,541 titled “Systems And Methods Of Providing Market Analytics For A Brand” filed on Oct. 17, 2008.

Although interface 400 is illustrated as a search engine interface, other computer interfaces can also be utilized. Preferred computer interfaces include application program interfaces (APIs) that provide access to a searchable database, or a web services API that enables researches to access analysis capabilities over a network, possibly the Internet.

In the example shown, a researcher can enter a query into an analysis engine via search field 410 where the query can comprise brand terms, term 270A for example. The analysis engine can lookup term combinations having term 270A and use at least some of the term combinations to search for web documents that are unrelated to a market domain (e.g., web documents that do not satisfy the market domain criteria), or simply lack reference to a market domain. For example, term 270A could indicate that the engine should look for web documents having terms 270C, or 270E due to the correlations found between these terms and term 270A (see FIG. 3A). The documents can then be returned as search results 412 and presented according to similarity scores of the correlated term combinations (see FIG. 3B).

It is also contemplated that an analysis search engine can present inferred search results 414 that includes web documents found via a chain of correlated term combinations. For example, terms 270A and 270B were found to be uncorrelated. However, both 270A and 270C were found to be correlated and 270C was found to be correlated to 270B. As a result, document C can be presented as an inferred search result 414 due to the indirect chain of correlated combinations of combination 2 and 4 of FIG. 3A.

In a preferred embodiment, the web documents resulting from searching unrelated web documents using the term combinations are presented via computer interface 400 according to the similarity scores of the term combinations. The presentation of the results can including ranking or displaying the results according to the similarity scores using many suitable methods. Preferred methods of presenting the results include ranking the web documents by similarity score, graphically displaying the results at a tag cloud where the size of the tags (e.g., terms) corresponds to the number of hits or scores, providing a spread sheet sorted by score, presenting a histogram of results, or even presenting results as a function of time showing history of scores to establish trends. The computer interface can also periodically update the results to reflect changes in web documents that satisfy a market domain criteria.

Searches for unrelated web documents that pertain to an analyses using the term combinations can be performed based on various combinations of the terms within the combinations. For example, documents can be found where each document has a single term, two or more of the terms in the combination, or the complete combination of terms.

One should appreciate that the disclosed subject matter is considered to include the concept of resolving names for various marketing or brand related entities including company names, product names, people names, brand names, technology names, trademarks, or other tags that can be considered a name associated with an entity. Correlated term combinations having strong similarity scores can be considered to indicate the terms within the term combination resolve (e.g., are synonymous) with each other. For example, the term “Sony” could have a strong similarity the term “TV” within web documents relating to a specific market domain, possibly defined by “Consumer Electronics”. This strong similarity indicates a high likelihood that, within the market domain of consumer electronic, “TV” resolves to or is synonymous with “Sony”.

Although the disclosed techniques are described within the concept of marketing, it is contemplated that the techniques can be easily adapted to other domains beyond marketing, possibly including medical diagnosis, document forensics, or other domains.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of identifying web documents pertaining a market domain, the method comprising:
classifying a first group of web documents as relating to a specified market domain;
identifying a set of brand term combinations, where each combination includes a first brand term and a second, different brand term occurring within the first group of web documents;
establishing a term correlation between the first term and the second term for each combination based on usage of the first and the second terms within the first group of web documents;
assigning a similarity score to each combination as a function of the term correlation;
searching for a second group of web documents unrelated to the specified market domain using at least some of combinations; and
presenting the second group of web documents via a computer interface according the similarity scores of the brand term combinations.

2. The method of claim 1, wherein the step of classifying is performed by a human being.

3. The method of claim 1, wherein the step of classifying includes automatically identifying the first group of web documents as a function of a search term representing the specified market domain.

4. The method of claim 3, wherein the search term comprises data selected from the group consisting of image data and audio data.

5. The method of claim 3, further comprising automatically updating the first group of web documents.

6. The method of claim 1, wherein the first group of web documents are sourced from e-commerce sites.

7. The method of claim 1, wherein the first group of web documents comprises reviews.

8. The method of claim 1, wherein the second group of web documents comprises articles.

9. The method of claim 8, wherein the articles comprises at least one of the following types of articles: a blog, a forum post, and a news story.

10. The method of claim 1, wherein the step of identifying the set of combinations includes ignoring terms on an exclusion list.

11. The method of claim 1, wherein the usage includes proximity of the first and the second term within individual ones of the first group of web documents.

12. The method of claim 1, wherein the usage includes frequency of occurrences of the first and the second terms within the first group of web documents.

13. The method of claim 1, wherein the usage includes a difference between digital data used to represent the first brand term and digital data used to represent the second brand term.

14. The method of claim 1, further comprising periodically updating the similarly score.

15. The method of claim 1, further comprising reducing the set of brand term combinations by eliminating combinations having similarity scores outside a threshold constraint.

16. The method of claim 1, wherein the step of presenting the second group of web documents includes providing a web services application program interface.

17. The method of claim 1, further comprising providing access to a history of the set of combinations having similarity scores for the specified market domain.
